(19) United States
(12) Patent Application Publication
(10) Pub. No.: US 2023/0156135 A1
(43) Pub. Date: May 18, 2023

(54) INFORMATION PROCESSING DEVICE, SCAN DATA PROCESSING METHOD, AND SCAN DATA PROCESSING PROGRAM

(71) Applicant: SEIKO EPSON CORPORATION, Tokyo (JP)

(72) Inventor: Yusuke NAKANO, Matsumoto-shi (JP)

(21) Appl. No.: 18/053,799

(22) Filed: Nov. 9, 2022

(30) Foreign Application Priority Data
Nov. 12, 2021 (JP) 2021-184958

(51) Int. Cl. H04N 1/32; H04N 1/387; H04N 1/21

(52) U.S. Cl. CPC H04N 1/32133; H04N 1/387; H04N 1/21

(57) ABSTRACT

An information processing device includes: a storage unit configured to store scan data read from a plurality of documents; and a processing unit configured to acquire information indicated by an identification code present in the plurality of documents based on the scan data and to edit the scan data according to the acquired information. The editing includes rearranging pages of the scan data according to the information.

The present application is based on, and claims priority from JP Application Serial Number 2021-184958, filed Nov. 12, 2021, the disclosure of which is hereby incorporated by reference herein in its entirety.

### BACKGROUND

### 1. Technical Field

The present disclosure relates to a technique for collecting electronic data of documents associated with common identification information.

### 2. Related Art

A document bundle including documents in which an identification code such as a barcode or a two-dimensional code is present is read, and electronic data of the documents associated with identification information obtained from the identification code are collected into one file.

An electronic document creation device disclosed in JP-A-2007-102545 reads a two-dimensional code included in a paper document, and collects electronic documents associated with the same two-dimensional code as the read two-dimensional code to create one new electronic document.

In combined sorting for collecting electronic data of documents associated with common identification information, it is desirable to appropriately collect the electronic data of the documents.

### SUMMARY

An information processing device according to an aspect of the present disclosure includes: a storage unit configured to store scan data read from a plurality of documents; and a processing unit configured to acquire, based on the scan data, information included in an identification code present in the plurality of documents, and generate, based on the scan data, extraction data obtained by collecting electronic data of documents associated with identification information included in the identification code among the plurality of documents, in which the information included in the identification code includes the identification information and sorting information for sorting a target of the identification information, and the processing unit generates the extraction data in which the electronic data are collected according to an order represented by the sorting information.

A scan data processing method according to an aspect of the present disclosure is a scan data processing method of processing scan data read from a plurality of documents, the method includes: an acquisition step of acquiring, based on the scan data, information included in an identification code present in the plurality of documents, and a generation step of generating, based on the scan data, extraction data obtained by collecting electronic data of documents associated with identification information included in the identification code among the plurality of documents, in which the information included in the identification code includes the identification information and sorting information for sorting a target of the identification information, and the generation step generates the extraction data in which the electronic data are collected according to an order represented by the sorting information.

Further, a non-transitory computer-readable storage medium according to an aspect of the present disclosure is a non-transitory computer-readable storage medium storing a scan data processing program configured to process scan data read from a plurality of documents, the program causing a computer to implement: an acquisition function of acquiring, based on the scan data, information included in an identification code present in the plurality of documents; and a generation function of generating, based on the scan data, extraction data obtained by collecting electronic data of documents associated with identification information included in the identification code among the plurality of documents, in which the information included in the identification code includes the identification information and sorting information for sorting a target of the identification information, and the generation function generates the extraction data in which the electronic data are collected according to an order represented by the sorting information.

### BRIEF DESCRIPTION OF THE DRAWINGS

FIG. 1 is a block diagram schematically showing a configuration example of an image reading system.

FIG. 2 is a diagram schematically showing an example of combined sorting in which electronic data of documents associated with common identification information are collected.

FIG. 3 is a diagram schematically showing an example of information included in an identification code.

FIG. 4 is a diagram schematically showing an example in which a part of the information included in the identification code is used as the identification information.

FIG. 5 is a diagram schematically showing a display example of a UI screen.

FIG. 6 is a diagram schematically showing an example of items in a classification method selection field.

FIG. 7 is a diagram schematically showing a display example of a digit position setting screen.

FIG. 8 is a flowchart showing an example of combined sorting processing.

FIG. 9 is a diagram schematically showing an example in which electronic data of documents are collected according to an order represented by sorting information.

FIG. 10 is a diagram schematically showing an example in which the electronic data of the documents are rearranged according to the order represented by the sorting information.

### DESCRIPTION OF EXEMPLARY EMBODIMENTS

Hereinafter, embodiments of the present disclosure will be described. Of course, the following embodiments are merely examples of the present disclosure, and all of features shown in the embodiments are not necessarily essential to the solution of the present disclosure.

### (1) Outline of Technique Included in Present Disclosure

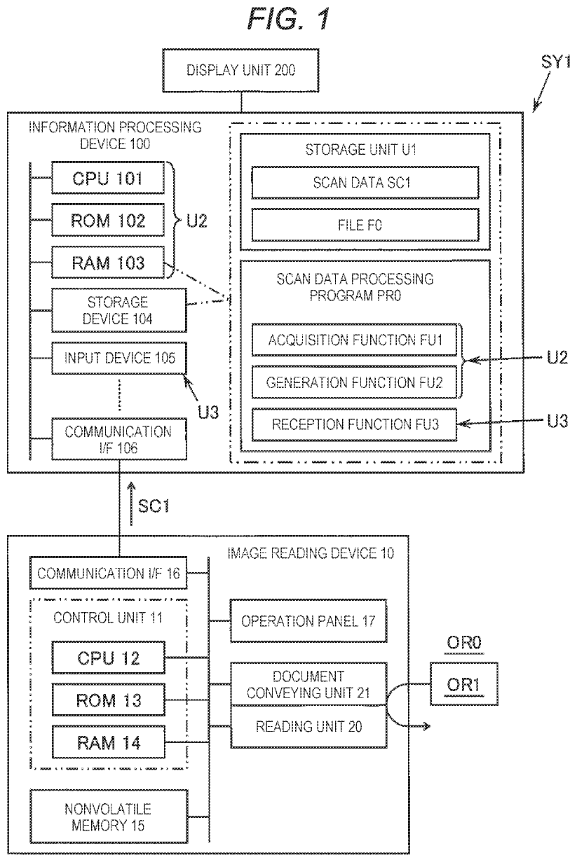

First, an outline of a technique included in the present disclosure will be described with reference to examples shown in FIGS. 1 to 10. Drawings of the present application are diagrams schematically showing examples, and enlargement ratios in respective directions shown in these drawings may be different from one another, and the drawings may not be consistent with one another. As a matter of course, each element of the present technique is not limited to the specific examples indicated by the reference numerals. In the “Outline of Technique Included in Present Disclosure”, the parenthesis means a supplementary explanation of an immediately preceding word.

### Aspect 1

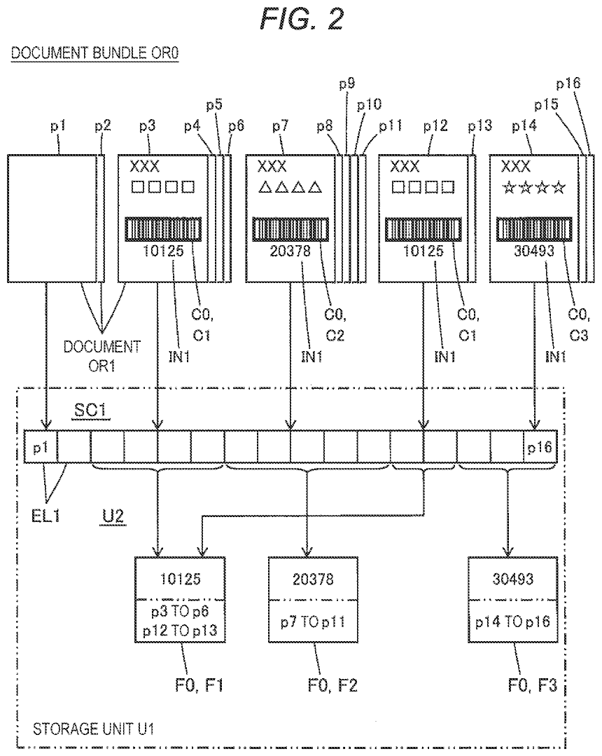

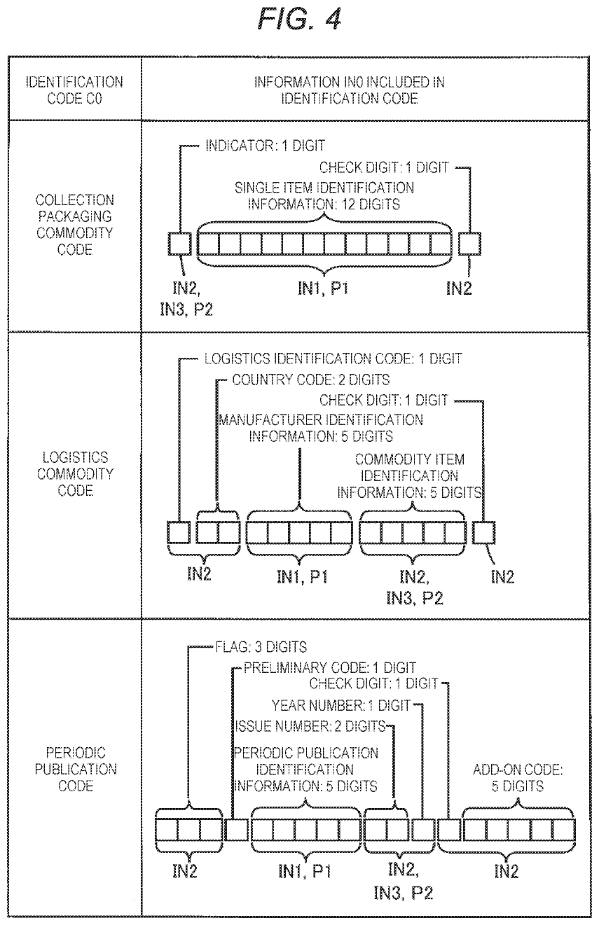

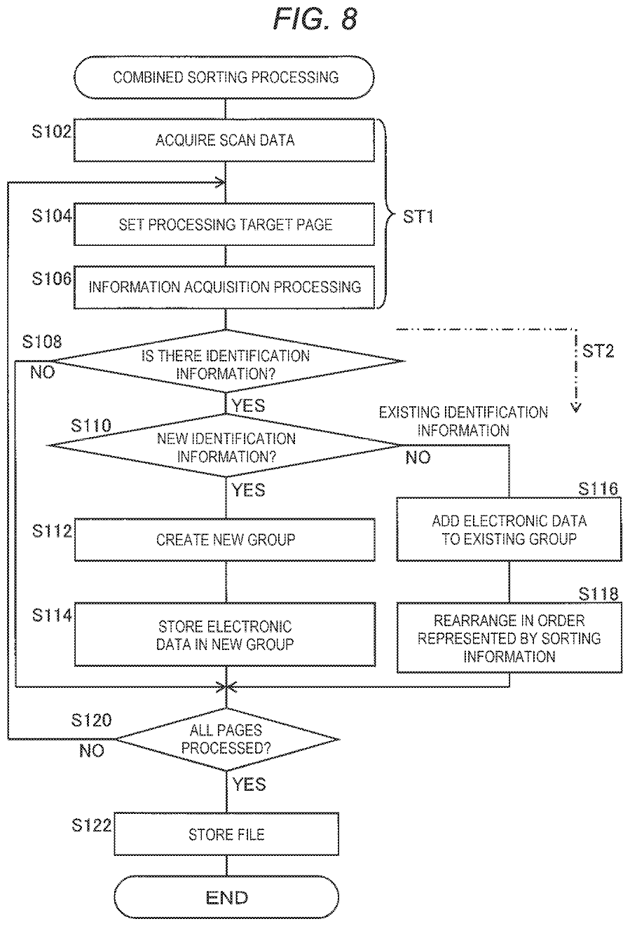

As shown in FIG. 1, an information processing device 100 according to an aspect of the present technique includes a storage unit U1 and a processing unit U2. The storage unit U1 stores scan data SC1 read from a plurality of documents OR1. The processing unit U2 acquires, based on the scan data SC1, information IN0 (for example, see FIG. 4) included in an identification code C0 present in the plurality of documents OR1, and generates, based on the scan data SC1, extraction data (for example, a file F0) obtained by collecting electronic data EL1 of the documents OR1 associated with identification information IN1 included in the identification code C0 among the plurality of documents OR1, as shown in FIG. 2 and the like. Here, the information IN0 included in the identification code C0 includes the identification information IN1 and sorting information IN3 for sorting a target of the identification information IN1. Here, the identification information IN1 may be referred to as first information, and the sorting information IN3 may be referred to as second information. As shown in FIGS. 8 to 10, the processing unit U2 generates the extraction data (F0) in which the electronic data EL1 are collected according to an order represented by the sorting information IN3.

In the aspect 1 described above, in the combined sorting for collecting the electronic data EL1 of the documents OR1 associated with the common identification information IN1, the electronic data EL1 of the documents OR1 are collected according to the order represented by the sorting information IN3 included in the identification code C0. Therefore, according to the aspect 1, the electronic data of the document can be appropriately collected.

Here, the identification code includes a barcode, a two-dimensional code, and the like.

The information included in the identification code may include information different from the identification information and the sorting information, such as a check digit and a price.

The above described additional statements are also applied to the following aspects.

### Aspect 2

As shown in FIGS. 4 to 7, the information processing device 100 may further include a reception unit U3 that receives a setting of a first presence portion P1 in which the identification information IN1 is present in the information IN0 included in the identification code C0. The processing unit U2 may acquire the identification information IN1 present in the first presence portion P1 from the information IN0 included in the identification code C0, or may generate the extraction data (F0) in which the electronic data EL1 associated with the acquired identification information IN1 are collected. In the present aspect, since a presence portion of the identification information IN1 can be set in the information IN0 included in the identification code C0, it is possible to improve workability at the time of the combined sorting.

Here, “first”, “second”, and so on in the present application are terms for identifying each component, and do not mean the order. The same applies to the following aspects.

### Aspect 3

The reception unit U3 may be capable of receiving a setting of a second presence portion P2 in which the sorting information IN3 is present in the information IN0 included in the identification code C0. When the setting of the second presence portion P2 is received, the processing unit U2 may acquire the sorting information IN3 present in the second presence portion P2 from the information IN0 included in the identification code C0, or may generate the extraction data (F0) in which the electronic data EL1 are collected according to the order represented by the acquired sorting information IN3. In the present aspect, since the presence portion of the sorting information IN3 can be set in the information IN0 included in the identification code C0, it is possible to further improve the workability at the time of the combined sorting.

### Aspect 4

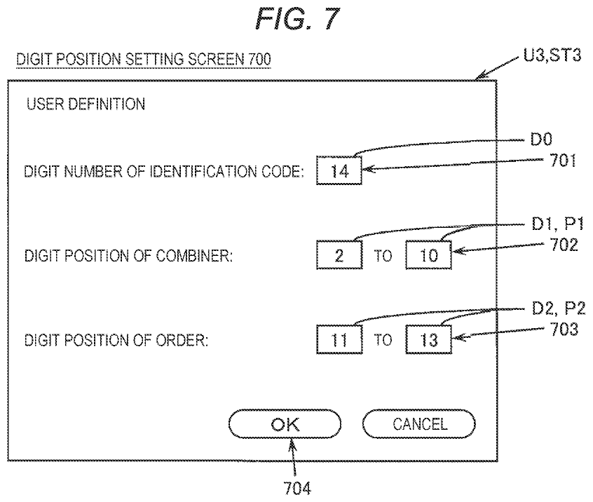

As shown in FIG. 7, the reception unit U3 may be capable of receiving a setting of a first digit D1 to be the first presence portion P1 and a second digit D2 to be the second presence portion P2 among a plurality of digits D0 corresponding to the information IN0 included in the identification code C0. When the setting of the first digit D1 is received, the processing unit U2 may acquire the identification information IN1 corresponding to the first digit D1 among the plurality of digits D0. When the setting of the second digit D2 is received, the processing unit U2 may acquire the sorting information IN3 corresponding to the second digit D2 among the plurality of digits D0. In the present aspect, it is possible to set the digit corresponding to the identification information IN1 and the digit corresponding to the sorting information IN3 among the plurality of digits D0 corresponding to the information IN0 included in the identification code C0. Therefore, it is possible to further improve the workability at the time of the combined sorting.

### Aspect 5

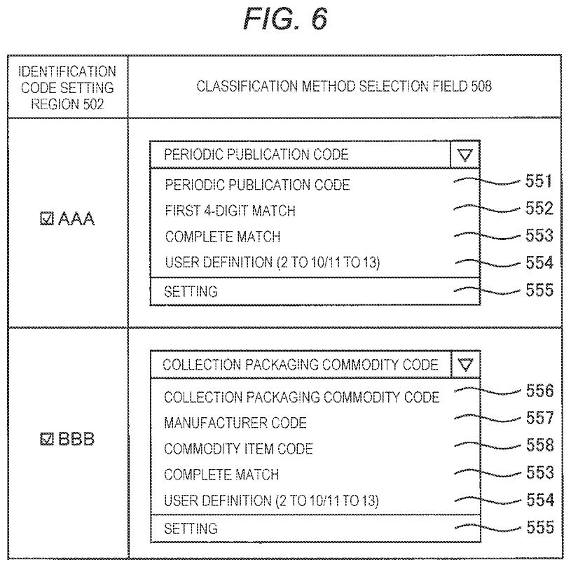

As shown in FIG. 6, the reception unit U3 may be capable of receiving a collection packaging commodity code acquisition setting (for example, a “collection packaging commodity code” item 556) for acquiring the information IN0 included in a collection packaging commodity code as the identification code C0. Upon receiving the collection packaging commodity code acquisition setting (556), as shown in FIG. 4, the reception unit U3 may set, in the information IN0 included in the collection packaging commodity code, a portion in which single item identification information for identifying a single item included in a collection packaging is present as the first presence portion P1, or may set a portion in which an indicator is present as the second presence portion P2. The present aspect can provide a preferable example in which the electronic data of the documents are collected according to the collection packaging commodity code.

### Aspect 6

As shown in FIG. 6, the reception unit U3 may be capable of receiving a periodic publication code acquisition setting (for example, a “periodic publication code” item 551) for acquiring the information IN0 included in a periodic publication code as the identification code C0. Upon receiving the periodic publication code acquisition setting (551), as shown in FIG. 4, the reception unit U3 may set, in the information IN0 included in the periodic publication code, a portion in which periodic publication code identification information for identifying the periodic publication is present as the first presence portion P1, or may set a portion in which an issue period (for example, an issue number and a year number) is present as the second presence portion P2. The present aspect can provide a preferable example in which the electronic data of the documents are collected according to the periodic publication code.

### Aspect 7

As shown in FIG. 6, the reception unit U3 may be capable of receiving a logistics commodity code acquisition setting (for example, a “manufacturer code” item 557) for acquiring the information IN0 included in a logistics commodity code as the identification code C0 including manufacturer identification information for identifying a manufacturer of a commodity item group and commodity item identification information for identifying a commodity item included in the commodity item group. Upon receiving the logistics commodity code acquisition setting (557), as shown in FIG. 4, the reception unit U3 may set, in the information IN0 included in the logistics commodity code, a portion in which the manufacturer identification information is present as the first presence portion P1, or may set a portion in which the commodity item identification information is present as the second presence portion P2. The present aspect can provide a preferable example in which the electronic data of the documents are collected according to the logistics commodity code including the manufacturer identification information and the commodity item identification

### Aspect 8

As shown in FIG. 6, the reception unit U3 may be capable of receiving a complete match setting (for example, a “complete match” item 553) in which the information IN0 included in the identification code C0 is used as the identification information IN1. Further, when the complete match setting (553) is received, the processing unit U2 may generate the extraction data (F0) in which the electronic data EL1 associated with the identification information IN1, which is the information IN0 included in the identification code C0, are collected without using the sorting information IN3. In the present aspect, since the information IN0 itself included in the identification code C0 in the combined sorting can be set as the identification information IN1, it is possible to further improve the workability at the time of the combined sorting.

### Aspect 9

As shown in FIG. 8, the processing unit U2 may set a processing target page in order from among a plurality of pages included in the scan data SC1. When the processing target page is associated with the identification information IN1 and the identification information IN1 is new identification information that appears for the first time, the processing unit U2 may create a storage location (for example, a new group) of the electronic data EL1 associated with the new identification information and then store the electronic data EL1 corresponding to the processing target page in the storage location. When the processing target page is associated with the identification information IN1 and the identification information IN1 is existing identification information that already appeared, the processing unit U2 may add the electronic data EL1 corresponding to the processing target page to a created storage location (for example, an existing group) of the electronic data EL1 associated with the existing identification information. The processing unit U2 may generate the extraction data (F0) in which the electronic data EL1 stored in each of the created storage locations are collected according to the order represented by the sorting information IN3. The present aspect can provide a preferable example of collecting the electronic data of the documents.

### Aspect 10

As shown in FIG. 1, the information processing device 100 may further include a communication unit (for example, a communication interface 106) that receives the scan data SC1 from the image reading device 10. The storage unit U1 may store the received scan data SC1. In the present aspect, since the extraction data (F0) can be generated from the scan data SC1 received from the image reading device 10, it is possible to improve the workability of the combined sorting.

Here, the image reading device includes a scanner, a facsimile, a multifunction device having a function of reading a document and a function of outputting image data, and the like. The same applies to the following aspects.

### Aspect 11

A scan data processing method according to an aspect of the present technique is a scan data processing method of processing the scan data SC1 read from the plurality of documents OR1, and includes the following steps (A1) and (A2).

(A1) An acquisition step ST1 (for example, steps S102 to S106 shown in FIG. 8) of acquiring, based on the scan data SC1, the information IN0 included in the identification code C0 present in the plurality of documents OR1.

(A2) A generation step ST2 (for example, steps S108 to S122 shown in FIG. 8) of generating, based on the scan data SC1, the extraction data (F0) obtained by collecting the electronic data EL1 of the documents OR1 associated with the identification information IN1 included in the identification code C0 among the plurality of documents OR1.

Here, the information IN0 included in the identification code C0 includes the identification information IN1 and the sorting information IN3 for sorting the target of the identification information IN1.

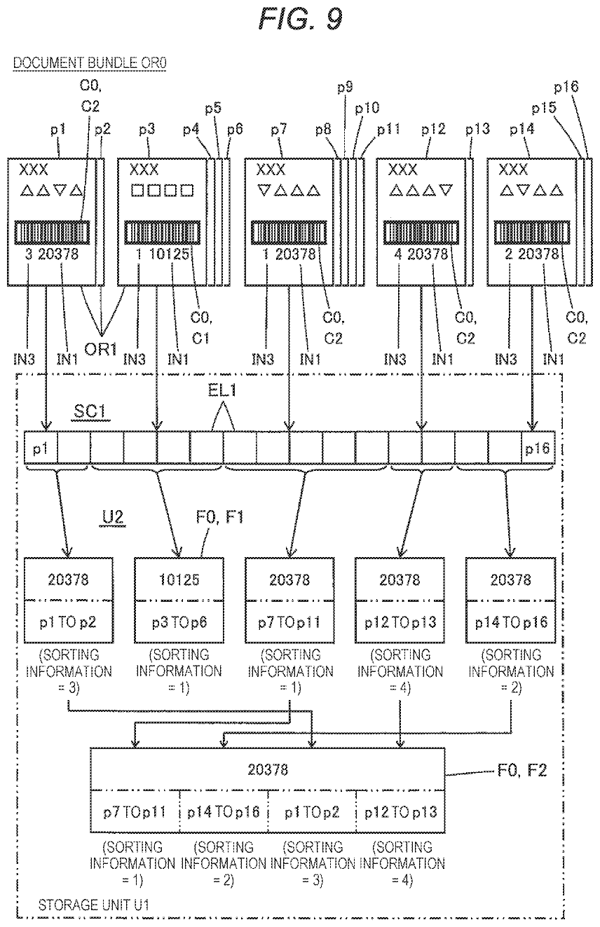

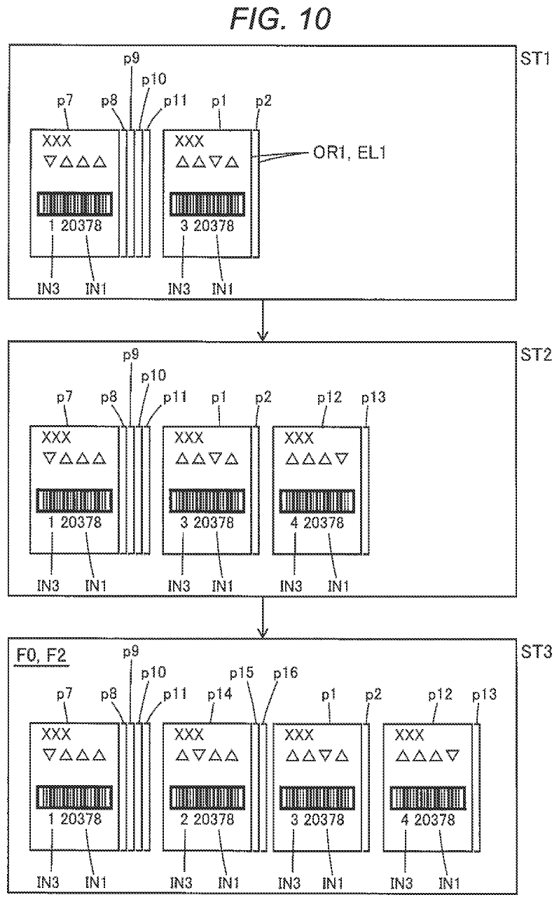

In the present scan data processing method, in the generation step ST2, the extraction data (F0) in which the electronic data EL1 are collected according to the order represented by the sorting information IN3 is generated (for example, see FIGS. 9 and 10).

In the aspect 11 described above, in the combined sorting in which the electronic data EL1 of the documents OR1 associated with the common identification information IN1 are collected, the electronic data EL1 of the documents OR1 are collected according to the order represented by the sorting information IN3 included in the identification code C0. Therefore, according to the aspect 11, it is possible to provide a scan data processing method of appropriately collecting the electronic data of the documents.

The scan data processing method may include a reception step ST3 corresponding to the reception unit U3.

### Aspect 12

As shown in FIG. 1, a scan data processing program PR0 according to an aspect of the present technique causes a computer (for example, the information processing device 100) to implement an acquisition function FU1 corresponding to the acquisition step ST1 and a generation function FU2 corresponding to the generation step ST2. According to the present aspect, it is possible to provide a scan data processing program for appropriately collecting the electronic data of the documents.

The scan data processing program PR0 may cause a computer to implement a reception function FU3 corresponding to the reception step ST3.

Further, the present technique is applicable to an image reading system including an information processing device and an image reading device, a control method of the image reading system, a control program of the image reading system, a computer-readable medium in which any one of the above described programs is recorded, and the like. The information processing device may include a plurality of distributed portions.

### (2) Specific Example of Image Reading System for Combined Sorting

FIG. 1 schematically shows a configuration of an image reading system SY1 including the image reading device 10 and the information processing device 100. FIG. 2 schematically shows the combined sorting that collects the electronic data EL1 of the documents OR1 associated with the common identification information IN1.

The image reading device 10 includes a reading unit 20 that generates the scan data SC1 by reading the documents OR1, and a document conveying unit 21 that conveys the documents OR1 to the reading unit 20 along a conveyance path passing through the reading unit 20, and performs a scan operation of sequentially reading the plurality of documents OR1. The information processing device 100 receives the scan data SC1 from the image reading device 10, and performs the combined sorting on the scan data SC1, as shown in FIG. 2.

The image reading device 10 shown in FIG. 1 further includes a control unit 11, a nonvolatile memory 15, a communication interface 16, and an operation panel 17. The control unit 11 includes a CPU 12, which is a processor, a ROM 13, which is a semiconductor memory, and a RAM 14, which is a semiconductor memory. Here, I/F shown in FIG. 1 is an abbreviation of an interface, CPU is an abbreviation of a central processing unit, ROM is an abbreviation of a read only memory, and RAM is an abbreviation of a random access memory. At least one of the ROM 13 and the nonvolatile memory 15 holds an image reading program. The CPU 12 executes the image reading program while using the RAM 14 as a work area, thereby performing various kinds of processing such as control processing of the operation panel 17, control processing of the reading unit 20, control processing of the document conveying unit 21, and output processing of the scan data SC1 of the documents OR1. A processor constituting the control unit 11 is not limited to one CPU, and may be a plurality of CPUs, a hardware circuit such as an ASIC, a combination of a CPU and a hardware circuit, or the like. Here, the ASIC is an abbreviation of an application specific integrated circuit. A semiconductor memory such as a flash memory, a magnetic recording medium such as a hard disk, or the like can be used as the nonvolatile memory 15.

The communication interface 16 transmits and receives data to and from the information processing device 100 connected in a wired or wireless manner according to a predetermined communication protocol. The communication interface 16 receives scan settings and the like from the information processing device 100, and transmits the scan data SC1 and the like to the information processing device 100. The connection between the communication interface 16 and the information processing device 100 may be a network connection such as a LAN or the Internet, or may be a local connection such as a USB connection. Here, LAN is an abbreviation for local area network, and USB is an abbreviation for universal serial bus.

The operation panel 17 may include a display panel that displays a screen and an operation reception unit that receives an operation on the screen. A display panel such as a liquid crystal panel can be used as the display panel. A touch panel attached to a surface of the display panel, a hard key including a keyboard, or the like can be used as the operation reception unit.

The reading unit 20 includes, for example, a light source that irradiates the document OR1 with light, an image sensor that performs photoelectric conversion, a light receiving optical system that guides reflected light from the document OR1 to the image sensor, an analog-digital conversion unit that converts an analog electric signal output from the image sensor into a digital pixel value group, and an image data storage processing unit that stores the scan data SC1 based on the pixel value group in the RAM 14. The reading unit 20 may read a front surface of the document OR1 with a front surface image sensor and read a back surface of the document OR1 with a back surface image sensor. In this case, the reading unit 20 generates the scan data SC1 by reading both sides of the document OR1.

The document conveying unit 21 includes, for example, a feed tray, a feed roller pair, a document separation unit, a multi-feed detection unit, a conveyance roller pair, a discharge roller pair, and a discharge tray. A document bundle OR0 in which the plurality of documents OR1 are stacked may be set on the feed tray. The document conveying unit 21 that successively feeds the plurality of documents OR1 to the reading unit 20 is called an ADF or an automatic paper feeding device. Here, the ADF is an abbreviation for auto document feeder. The reading unit 20 sequentially reads the plurality of documents OR1 included in the document bundle OR0 to generate the scan data SC1 corresponding to the plurality of documents OR1.

The image reading device 10 is not limited to a scanner dedicated machine, and may be a multifunction device having at least a part of a printing function, a facsimile communication function, an e-mail transmission function, and the like. The image reading device 10 may include all components in one housing, and may be configured by a plurality of devices that are divided so as to be able to communicate with each other.

The information processing device 100 shown in FIG. 1 includes a CPU 101 which is a processor, a ROM 102 which is a semiconductor memory, a RAM 103 which is a semiconductor memory, a storage device 104, an input device 105, and the communication interface 106. The scan data processing program PR0 for causing the computer to function as the information processing device 100 is stored in the storage device 104, read out to the RAM 103 by the CPU 101, and executed by the CPU 101. The scan data processing program PR0 may be referred to as driver software for controlling the image reading device 10 or may be referred to as a scanner driver. The plurality of functions implemented by the information processing device 100 by the scan data processing program PR0 include the acquisition function FU1 of the information IN0, the generation function FU2 of the file F0, and the reception function FU3 of the identification information IN1, the sorting information IN3, and the like, as shown in FIG. 2. Here, the file F0 is an example of the extraction data in which the electronic data EL1 of the documents associated with the identification information IN1 among the plurality of read documents OR1 are collected. The acquisition function FU1 and the generation function FU2 correspond to the processing unit U2 together with the CPU 101, the ROM 102, and the RAM 103. The reception function FU3 corresponds to the reception unit U3 for the identification information IN1, the sorting information IN3, and the like together with the input device 105. The CPU 101 executes the scan data processing program PR0 while using the RAM 103 as a work area, thereby causing the information processing device 100 to implement the above described functions FU1 to FU3 and the like and performing various kinds of processing.

A processor constituting the information processing device 100 is not limited to one CPU, and may be a plurality of CPUs, a hardware circuit such as an ASIC, a combination of a CPU and a hardware circuit, or the like.

A semiconductor memory such as a flash memory, a magnetic recording medium such as a hard disk, or the like can be used as the storage device 104. When the scan data processing program PR0 is stored in the storage device 104, the storage device 104 becomes a computer-readable medium in which the scan data processing program PR0 is recorded. Of course, the scan data processing program PR0 may be recorded in an external recording medium and read from the external recording medium into the information processing device 100. In this case, the external recording medium is a computer-readable medium in which the scan data processing program PR0 is recorded.

In the present specific example, at least one of the RAM 103 and the storage device 104 is the storage unit U1 that stores the scan data SC1 read from the plurality of documents OR1 included in the document bundle OR0. That is, the scan data SC1 may be temporarily stored in the RAM 103, may be stored in the storage device 104 for long-term storage, or may be stored in both the RAM 103 and the storage device 104. The storage unit U1 in the present specific example stores the file F0 generated from the scan data SC1. That is, the file F0 may be temporarily stored in the RAM 103, may be stored in the storage device 104 for long-term storage, or may be stored in both the RAM 103 and the storage device 104. A file in a PDF format, a file in a document format, or the like can be adopted as the file F0.

A pointing device, a hard key including a keyboard, a touch panel attached to a surface of a display panel, or the like can be used as the input device 105. The communication interface 106 is connected to the communication interface 16 of the image reading device 10 in a wired or wireless manner, and transmits and receives data to and from the image reading device 10 according to a predetermined communication protocol. The communication interface 106 transmits scan settings and the like to the image reading device 10, and receives the scan data SC1 and the like from the image reading device 10. The communication interface 106 is an example of a communication unit. As described above, the connection between the communication interfaces 106 and 16 may be a network connection such as a LAN or the Internet, or may be a local connection such as a USB connection.

The information processing device 100 includes a computer such as a personal computer including a tablet terminal, a mobile phone such as a smartphone, and the like. For example, when a computer main body in a desktop personal computer is applied to the information processing device 100, a display unit 200 is usually connected to the computer main body. When the information processing device 100 outputs display data to the display unit 200, the display unit 200 displays a screen corresponding to the display data. When a display-integrated computer such as a notebook personal computer is applied to the information processing device 100, the information processing device 100 outputs the display data to the internal display unit 200. The information processing device 100 may have all components in one housing, but may be configured by a plurality of devices divided so as to be able to communicate with each other. Further, the present technique can be implemented even when at least a part of the image reading device 10 is inside the information processing device 100.

Next, an example of the combined sorting will be described with reference to FIG. 2. The document bundle ORO shown in FIG. 2 means a collection of the plurality of documents OR1 for generating one scan data SC1, and may be set on the feed tray of the image reading device 10 in a plurality of separate times. FIG. 2 shows that the document bundle ORO includes the documents OR1 from page 1 (p1) to including the electronic data EL1 from the page 1 (p1) to the page 16 (p16). Hereinafter, a page number is simply indicated by “p +number”. Each page of the scan data SC1 may be the electronic data EL1 on one side of the document OR1 or the electronic data EL1 on both sides of the document OR1.

The document bundle OR0 includes a document having the identification code C0. The processing unit U2 that performs the combined sorting acquires the identification information IN1 included in the identification code C0 present in the plurality of documents OR1 based on the scan data SC1. When a plurality of identification codes C0 are present in the plurality of documents OR1, the processing unit U2 acquires the identification information IN1 included in all the identification codes C0. In the document bundle OR0 shown in FIG. 2, identification codes C1 are present in p3 and p12, an identification code C2 is present in p7, and an identification code C3 is present in p14. In this case, the processing unit U2 acquires identification information “10125” included in the identification codes C1, acquires identification information “20378” included in the identification code C2, and acquires identification information “30493” included in the identification code C3. Here, the identification codes C1, C2, and C3 are included in the identification code C0, and the identification information “10125”, “20378”, and “30493” are included in the identification information IN1.

The processing unit U2 associates the identification information IN1 with the electronic data EL1 of the documents that can be associated with the identification information IN1 among the plurality of documents OR1. When a plurality of types of identification information IN1 are acquired, the processing unit U2 generates, in the storage unit U1, the file F0 in which the electronic data EL1 of the documents OR1 are collected for each type of identification information IN1. Here, the processing unit U2 collects at least a page from a page from which certain identification information IN1 is acquired to a page immediately before different identification information IN1 is acquired. For example, it is assumed that the identification information “10125” is acquired at p3, the identification information IN1 is not acquired at p4 to p6, and the identification information “20378” is acquired at p7. In this case, p3 to p6 are associated with the identification information “10125”, and the electronic data EL1 of p3 to p6 are included in one file F1 corresponding to the identification information “10125”. Further, it is assumed that the identification information “20378” is acquired at p7, the identification information IN1 is not acquired at p8 to p11, and the identification information “10125” is acquired at p12. In this case, p7 to p11 are associated with the identification information “20378”, and the electronic data EL1 of p7 to p11 are included in one file F2 corresponding to the identification information “20378”. Further, it is assumed that the identification information “10125” is acquired at p12, the identification information IN1 is not acquired at p13, and the identification information “30493” is acquired at p14. In this case, p12 and p13 are associated with the identification information “10125”, and the electronic data EL1 of p12 and p13 are added to one file F1 corresponding to the identification information “10125”. The files F1, F2, and F3 shown in FIG. 2 are included in the file F0.

As described above, from the scan data SC1 shown in FIG. 2, the file F1 including the electronic data EL1 of p3 to p6 and p12 and p13 is generated, the file F2 including the electronic data EL1 of p7 to p11 is generated, and the file F3 including the electronic data EL1 of p14 to p16 is generated.

When it is not necessary to store the electronic data EL1 of the documents OR1 having the identification code CO, the processing unit U2 may generate the file F0 excluding the electronic data EL1 of the documents OR1 having the identification code C0.

### (3) Specific Example of Information Included in Identification Code

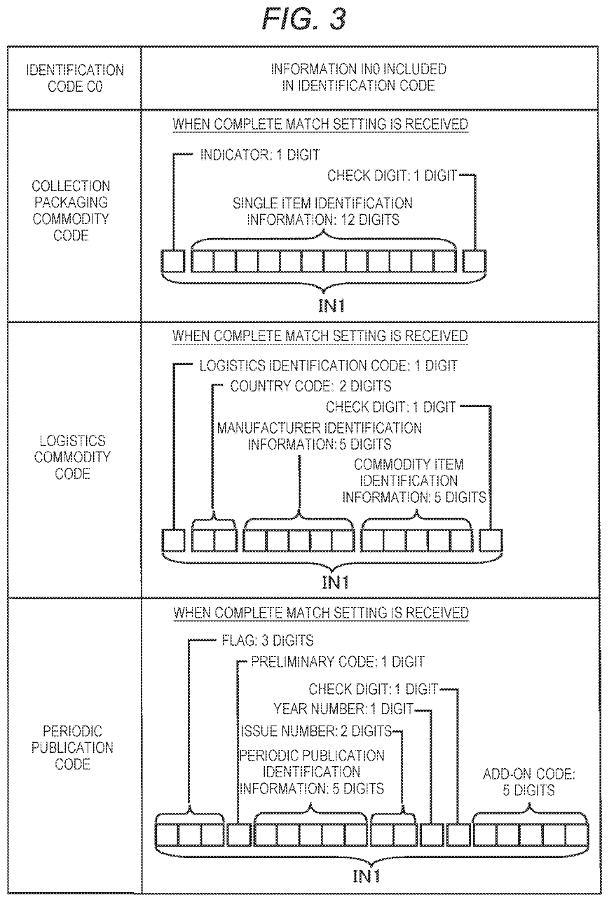

FIG. 3 schematically shows the information IN0 included in the identification code C0.

For example, a collection packaging commodity code is known as the identification code C0. The collection packaging commodity code is included in global trade item number, which is abbreviated as GTIN, and is called GTIN-14. The collection packaging commodity code is a barcode set for collection packaging such as a case, a ball, or a pallet, and is represented by an interleaved two of five (ITF) symbol. The collection packaging commodity code includes a first 1-digit indicator, 12-digit single item identification information subsequent to the indicator, and a last 1-digit check digit. There are eight types of indicators “1” to “8”. The single item identification information is the first 12 digits of GTIN-13 called a Japanese article number (JAN) code, and can be referred to be information for identifying a single item included in the collection packaging. The check digit is uniquely set from the first 13 digits of the collection packaging commodity code. When the complete match setting in which the information IN0 included in the identification code C0 is set as the identification information IN1 is received, the 14-digit information IN0 present in the collection packaging commodity code is treated as the identification information IN1 as it is.

ITF-14, which is an ITF code represented by a 14-digit ITF symbol, can be referred to be a logistics commodity code including manufacturer identification information and commodity item identification information. The logistics commodity code as the identification code C0 shown in FIG. 3 includes a first 1-digit logistics identification code, a 2-digit country code subsequent to the logistics identification code, 5-digit manufacturer identification information subsequent to the country code, 5-digit commodity item identification information subsequent to the manufacturer identification information, and a last 1-digit check digit. The 2-digit country code is information for identifying a country. The manufacturer identification information is information for identifying a manufacturer of a commodity item group. The commodity item identification information is information for identifying a commodity item included in the commodity item group. The check digit is uniquely set from the first 13 digits of the logistics commodity code. When the complete match setting in which the information IN0 included in the identification code C0 is set as the identification information IN1 is received, the 14-digit information IN0 present in the logistics commodity code is treated as the identification information IN1 as it is.

As the identification code C0, a periodic publication code is known. The periodic publication code is represented by 18 digits in which a 5-digit add-on code for price representation is added to 13 digits conforming to the GTIN-13 called the JAN code, and is a barcode set for a periodic publication such as a magazine and a newspaper. The periodic publication code shown in FIG. 3 includes a first 3-digit flag, a 1-digit preliminary code subsequent to the flag, 5-digit periodic publication identification information subsequent to the preliminary code, a 2-digit issue number subsequent to the periodic publication identification information, a 1-digit year number subsequent to the issue number, a 1-digit check digit subsequent to the year number, and a 5-digit add-on code subsequent to the check digit. The periodic publication identification information is information for identifying a periodic publication. The issue number is information for identifying a period in an issue year, such as a month issue number signifying an issue month. The year number represents the last one digit of the Gregorian calendar. Therefore, the 2-digit issue number and the 1-digit year number mean an issue period having three digits. The check digit is uniquely set from the first 13 digits of the periodic publication code. The 5-digit add-on code is information such as a main unit price in yen. When the complete match setting in which the information IN0 included in the identification code C0 is set as the identification information IN1 is received, the 14-digit information IN0 present in the periodic publication code is treated as the identification information IN1 as it is.

As shown in FIG. 4, the identification information IN1 is a part of the information IN0 included in the identification code C0 when the complete match setting is not received. FIG. 4 schematically shows an example in which a part of the information IN0 included in the identification code C0 is set as the identification information IN1.

For example, the identification information IN1 included in the collection packaging commodity code may be 12-digit single item identification information. In this case, 1-digit indicator and 1-digit check digit are attached information IN2 attached to the identification information IN1. The 1-digit indicator can also be referred to be the sorting information IN3 for sorting a single item which is a target of the single item identification information.

The identification information IN1 included in the logistics commodity code shown in FIG. 4 may be 5-digit manufacturer identification information. In this case, 1-digit logistics identification code, 2-digit country code, 5-digit commodity item identification information, and 1-digit check digit are the attached information IN2 attached to the identification information IN1. The 5-digit commodity item identification information can also be referred to as the sorting information IN3 for sorting a manufacturer that is the target of the manufacturer identification information.

The identification information IN1 included in the periodic publication code shown in FIG. 4 may be 5-digit periodic publication identification information. In this case, the 3-digit flag, the 1-digit preliminary code, the 2-digit issue number, the 1-digit year number, the 1-digit check digit, and the 5-digit add-on code are the attached information IN2 attached to the identification information IN1. The 2-digit issue number and the 1-digit year number can also be referred to as the sorting information IN3 for sorting the periodic publication, which is the target of the periodic publication identification information.

By the way, in the complete match setting, when a plurality of identification codes C0 are allocated to a common target, the combined sorting is performed for each identification code C0 to generate the file F0. For example, when there are case-unit commodities and palette-unit commodities as a collection packaging of a common commodity, different collection packaging commodity codes are allocated to the case-unit commodities and palette-unit commodities. In this case, the file F0 in which the electronic data EL1 of the documents OR1 associated with the case-unit commodities are collected and the file F0 in which the electronic data EL1 of the documents OR1 associated with the palette-unit commodities are collected are separately generated. However, since the target of these files F0 is the same commodity, usability is improved when the electronic data EL1 of the documents OR1 associated with the commodities can be collected into one file F0.

When a part of the information IN0 included in the identification code C0 is set to the identification information IN1, even if a plurality of identification codes C0 are allocated to a common target, the electronic data EL1 of the documents OR1 associated with the common target are collected into one file F0. However, when the electronic data EL1 are collected into one file F0 in a reading order of the documents OR1 included in the document bundle OR0, a large amount of electronic data EL1 may be collected into one file F0 in a jumbled manner. For example, when there are periodic publications of various issue dates for the common periodic publication, when the electronic data EL1 are collected into one file F0 in a reading order of the documents OR1 regardless of the issue date, it may be difficult to search for the electronic data EL1 generated from the periodic publications of a desired issue date. When the electronic data EL1 can be collected into one file F0 in the order of the issue date of the periodic publication, the usability is improved.

The information processing device 100 in the present specific example generates the file F0 in which the electronic data EL1 of the documents OR1 are collected according to the order represented by the sorting information IN3 for sorting the target of the identification information IN1. Accordingly, the electronic data EL1 of the documents OR1 can be appropriately collected, and the usability can be improved.

### (4) Specific Example of Processing Performed by Information Processing Device

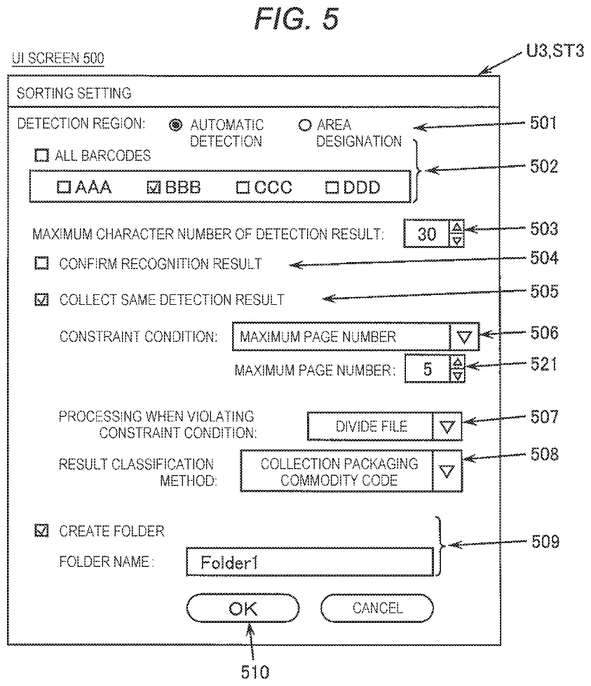

FIG. 5 schematically shows a UI screen 500 displayed on the display unit 200. Here, UI is an abbreviation of a user interface. Upon receiving an operation of instructing a setting of the combined sorting through the input device 105, the reception unit U3 of the information processing device 100 causes the display unit 200 to display the UI screen 500.

The UI screen 500 shown in FIG. 5 includes a detection region setting region 501, an identification code setting region 502, a detected maximum character number setting region 503, a recognition result confirmation check region 504, a combined sorting check region 505, a constraint condition selection field 506, a violation processing selection field 507, a classification method selection field 508, a storage destination setting region 509, an OK button 510, and the like. The information processing device 100 performs the reception step ST3 of receiving a setting of the identification information IN1, the sorting information IN3, and the like by receiving an operation on the UI screen 500 through the input device 105.

The detection region setting region 501 is a display region for receiving a setting of a region for detecting the identification code C0 from each document OR1. The reception unit U3 receives a selection item of either “automatic detection” or “area designation” in the detection region setting region 501. The “automatic detection” is a selection item for detecting the identification code C0 from an entire range of the documents OR1. The “area designation” is a selection item for designating a region in which the identification code C0 is to be detected in the entire range of the documents OR1. When the “area designation” is selected, the reception unit U3 causes the display unit 200 to display a screen, which is not shown, that receives a designation of a region in which the identification code C0 is to be detected, and receives the designation of the region in which the identification code C0 is to be detected on the screen.

The identification code setting region 502 is a display region for receiving a setting of a type of the identification code C0 to be detected. In FIG. 5, “AAA”, “BBB”, “CCC”, and “DDD” are shown as the types of the identification code C0. The items include the identification code C0 shown in FIGS. 3 and 4, for example, the collection packaging commodity code, the logistics commodity code, and the periodic publication code. The reception unit U3 receives the setting of one or more items among the plurality of items shown in FIG. 5.

The detected maximum character number setting region 503 is a display region for receiving a setting of a maximum character number of the information IN0 acquired from the identification code C0. When the reception unit U3 receives the setting of the maximum character number in the detected maximum character number setting region 503, the information IN0 is acquired from the identification code C0 within a range of the maximum character number.

The recognition result confirmation check region 504 is a display region for receiving a setting of whether to display the detected identification code C0. When the recognition result confirmation check region 504 is checked, the detected identification code C0 is displayed on the display unit 200.

The combined sorting check region 505 is a display region for receiving a setting of whether to perform the combined sorting. When the combined sorting check region 505 is checked, the combined sorting to which the present technique is applied is performed. Hereinafter, the description will be made on the premise that the combined sorting check region 505 is checked.

The constraint condition selection field 506 is a display region for receiving a setting of a constraint condition to be satisfied by the file F0 in which the electronic data EL1 of the documents OR1 associated with the identification information IN1 are collected. The reception unit U3 receives selection of any one item from among “maximum page number”, “minimum page number”, “even-odd page number”, “range designation of page number”, and “no” in the constraint condition selection field 506.

The “maximum page number” as the constraint condition is a selection item for setting an upper limit of a page number of the file F0 generated from the scan data SC1. When the “maximum page number” is selected, the reception unit U3 causes the display unit 200 to display a maximum page number setting region 521 under the constraint condition selection field 506 in the UI screen 500. In the maximum page number setting region 521, the reception unit U3 receives a setting of the maximum page number of the file F0 through the input device 105. The “minimum page number” as the constraint condition is a selection item for setting a lower limit of the page number of the file F0 generated from the scan data SC1. When the “minimum page number” is selected, the reception unit U3 receives a setting of the minimum page number of the file F0 in a minimum page number setting region, which is not shown. The “even-odd page number” as the constraint condition is a selection item for setting whether the page number of the file F0 generated from the scan data SC1 should be an even number or an odd number. When the “even-odd page number” is selected, the reception unit U3 receives one of selection items of “even number” and “odd number” in an even-odd number setting region, which is not shown. The “range designation of page number” as the constraint condition is a selection item for setting a range of the page number of the file F0 generated from the scan data SC1. The reception unit U3 receives the setting of the minimum page number and the maximum page number in the file F0 in a page number range setting region, which is not shown, through the input device 105. The “no” is a selection item for not setting a constraint condition.

The violation processing selection field 507 is a display region for receiving a setting of specific processing to be performed when a generation result of the file F0 is against the constraint condition. The reception unit U3 receives selection of any one item from among “divide file”, “display error”, and “suspend job” in the violation processing selection field 507.

The item “divide file” is a selection item for setting division processing of dividing the file F0 as the specific processing. When the “divide file” is selected, the processing unit U2 of the information processing device 100 divides the file F0 so as to be within the maximum page number when the “maximum page number” is set, and divides the file F0 so that one of the divided files becomes an even number or an odd number set in the even-odd number setting region when the “even-odd page number” is set. The “display error” is a selection item for setting error display processing for displaying an error as the specific processing. When the “display error” is selected, the processing unit U2 displays an error on the display unit 200 when the generation result of the file F0 is against the constraint condition. The “suspend job” is a selection item for setting suspension processing in which the file F0 is not stored as the specific processing. When the “suspend job” is selected, the processing unit U2 does not store the file F0 when the generation result of the file F0 is against the constraint condition.

The classification method selection field 508 is a display region for receiving a setting of the identification information IN1 associated with the documents OR1 and the sorting information IN3 for sorting the target of the identification information IN1 among the information IN0 included in the identification code C0. The reception unit U3 receives selection of an item shown in FIG. 6 in the classification method selection field 508. Details of the selection item of the identification information IN1 and the sorting information IN3 will be described later.

The storage destination setting region 509 is a display region for receiving a setting of a location where the file F0 is stored. When the reception unit U3 receives a setting of a storage destination of the file F0 in the storage destination setting region 509, the file F0 is stored in the storage destination.

Upon receiving an operation of the OK button 510 through the input device 105, the reception unit U3 stores the setting received in the above described display regions (501 to 509) in the storage unit U1, and deletes the UI screen 500 from the display unit 200.

FIG. 6 schematically shows items of the classification method selection field 508.

The items of the classification method selection field 508 change according to the setting in the identification code setting region 502 shown in FIG. 5. For example, when “AAA” is checked in the identification code setting region 502, the items of the classification method selection field 508 include a “periodic publication code” item 551, a “first 4-digit match” item 552, a “complete match” item 553, a “user definition” item 554, and a “setting” item 555. When “BBB” is checked in the identification code setting region 502, the items of the classification method selection field 508 include a “collection packaging commodity code” item 556, a “manufacturer code” item 557, a “commodity item code” item 558, the “complete match” item 553, the “user definition” item 554, and the “setting” item 555. Here, the “collection packaging commodity code” item 556 is an example of the collection packaging commodity code acquisition setting for acquiring the information IN0 included in the collection packaging commodity code shown in FIG. 4. The “manufacturer code” item 557 is an example of the logistics commodity code acquisition setting for acquiring the information IN0 included in the logistics commodity code including the manufacturer identification information and the commodity item identification information. The “periodic publication code” item 551 is an example of the periodic publication code acquisition setting for acquiring the information IN0 included in the periodic publication code. The “complete match” item 553 is an example of the complete match setting in which the information IN0 included in the identification code C0 is used as the identification information IN1. The user can select any one of the plurality of items in the classification method selection field 508. The reception unit U3 receives, in the classification method selection field 508, the setting of the first presence portion P1 in which the identification information IN1 is present and the setting of the second presence portion P2 in which the sorting information IN3 is present in the information IN0 included in the identification code C0.

For example, the “collection packaging commodity code” item 556 is a selection item for using, among the 14-digit information IN0 included in the collection packaging commodity code shown in FIG. 4, the 12-digit single item identification information as the identification information IN1 and the first 1-digit indicator as the sorting information IN3. Here, in the 14-digit information IN0 included in the collection packaging commodity code, a portion in which the 12-digit single item identification information is present corresponds to the first presence portion P1, and a portion in which the first 1-digit indicator is present corresponds to the second presence portion P2. Upon receiving the selection of the “collection packaging commodity code” item 556, the reception unit U3 sets the portion in which the single item identification information is present in the information IN0 included in the collection packaging commodity code as the first presence portion P1, and sets the portion in which the indicator is present as the second presence portion P2.

The “manufacturer code” item 557 is a selection item for using, among the 14-digit information IN0 included in the logistics commodity code shown in FIG. 4, the 5-digit manufacturer identification information as the identification information IN1 and the 5-digit commodity item identification information as the sorting information IN3. Here, in the 14-digit information IN0 included in the logistics commodity code, a portion in which the 5-digit manufacturer identification information is present corresponds to the first presence portion P1, and a portion in which the 5-digit commodity item identification information is present corresponds to the second presence portion P2. Upon receiving the selection of the “manufacturer code” item 557, the reception unit U3 sets, in the information IN0 included in the logistics commodity code, the portion in which the manufacturer identification information is present as the first presence portion P1 and the portion in which the commodity item identification information is present as the second presence portion P2.

The “commodity item code” item 558 is a selection item for using the 5-digit commodity item identification information as the identification information IN1 and the 5-digit manufacturer identification information as the sorting information IN3. In this way, it is also possible to change the portions used for the identification information IN1 and the sorting information IN3 in the information IN0 included in the identification code C0.

The “periodic publication code” item 551 is a selection item for using, among the 18-digit information IN0 included in the periodic publication code shown in FIG. 4, the 5-digit periodic publication identification information as the identification information IN1 and the 3-digit issue period as the sorting information IN3. In the example shown in FIG. 4, the 3-digit issue period is formed of the 2-digit issue number and the 1-digit year number. Here, in the 18-digit information IN0 included in the periodic publication code, a portion where the 5-digit periodic publication identification information is present corresponds to the first presence portion P1, and a portion where the 3-digit issue period is present corresponds to the second presence portion P2. Upon receiving the selection of the “periodic publication code” item 551, the reception unit U3 sets, in the information IN0 included in the periodic publication code, the portion in which the periodic publication identification information is present as the first presence portion P1 and the portion in which the issue period is present as the second presence portion P2.

The “first 4-digit match” item 552 is a selection item for using the first four digits of the information IN0 included in the identification code C0 as the identification information IN1. In this case, as the sorting information IN3, at least a part of the attached information IN2 obtained by excluding the first four digits from the information IN0 included in the identification code C0 can be used.

As shown in FIG. 3, the “complete match” item 553 is a selection item for using the information IN0 included in the identification code C0 as the identification information IN1 as it is. When the “complete match” item 553 is received, the file F0 is generated in which the electronic data EL1 associated with the identification information IN1, which is the entire information IN0, are collected without using the sorting information IN3. The “complete match” item 553 can also be referred to be an item for setting the entire information IN0 to the first presence portion P1.

The “user definition” item 554 is a selection item for using, among the information IN0 included in the identification code C0, the first presence portion P1 set by the user as the identification information IN1 and the second presence portion P2 set by the user as the sorting information IN3. The “user definition” item 554 shown in FIG. 6 means that the second to 10-th digits of the information IN0 included in the identification code C0 are used as the identification information IN1, and the 11-th to 13-th digits are used as the sorting information IN3. The “setting” item 555 is a selection item for setting the first presence portion P1 and the second presence portion P2 in the “user definition” item 554. Upon receiving the selection of the “user definition” item 554, the reception unit U3 displays a digit position setting screen 700 shown in FIG. 7 on the display unit 200.

FIG. 7 schematically shows the digit position setting screen 700 displayed on the display unit 200.

The digit position setting screen 700 shown in FIG. 7 includes a digit number setting region 701, a first digit setting region 702, a second digit setting region 703, an OK button 704, and the like. Here, a “combiner” means the identification information IN1. An “order” means the sorting information IN3. The information processing device 100 performs the reception step ST3 of receiving the setting of the identification information IN1, the sorting information IN3, and the like by receiving an operation on the digit position setting screen 700 through the input device 105.

The digit number setting region 701 is a display region for receiving a setting of a digit number corresponding to the information IN0 included in the identification code C0 to which the user definition is applied. The reception unit U3 receives the setting of the digit number in the digit number setting region 701 through the input device 105. The digit number to be set corresponds to the plurality of digits D0 corresponding to the information IN0 included in the identification code C0.

The first digit setting region 702 is a display region for receiving a setting of the first digit D1 to be the first presence portion P1 in which the identification information IN1 is present among the plurality of digits D0 described above. In the first digit setting region 702, the reception unit U3 receives, through the input device 105, from which digit to which digit among the plurality of digits D0 is to be set as the first digit D1. FIG. 7 shows that the second to 10-th digits among the 14 digits of the identification code C0 are input as the first digit D1. When the setting of the first digit D1 is received, the processing unit U2 of the information processing device 100 acquires the identification information IN1 corresponding to the second to 10-th digits among the 14-digit identification code C0.

The second digit setting region 703 is a display region for receiving a setting of the second digit D2 to be the second presence portion P2 in which the sorting information IN3 is present among the plurality of digits D0 described above. In the second digit setting region 703, the reception unit U3 receives, through the input device 105, from which digit to which digit among the plurality of digits D0 is to be set as the second digit D2. FIG. 7 shows that the 11-th to 13-th digits among the 14 digits of the identification code C0 are input as the second digit D2. When the setting of the second digit D2 is received, the processing unit U2 of the information processing device 100 acquires the sorting information IN3 corresponding to the 11-th to 13-th digits among the 14-digit identification code C0.

Upon receiving an operation of the OK button 704 through the input device 105, the reception unit U3 stores the setting received in the above described display regions (701 to 703) in the storage unit U1, and deletes the digit position setting screen 700 from the display unit 200. As a result, the display of the display unit 200 returns to the UI screen 500 shown in FIG. 5.

FIG. 8 shows the combined sorting processing performed by the processing unit U2 of the information processing device 100. When the image reading device 10 reads the document bundle OR0, the processing unit U2 starts the combined sorting processing. Here, steps S102 to S106 correspond to the acquisition step ST1 of the identification information IN1 and the acquisition function FU1 shown in FIG. 1. Steps S108 to S122 correspond to the generation step ST2 of the file F0 and the generation function FU2 shown in FIG. 1. Hereinafter, the description of “step” may be omitted, and the reference numerals of the steps may be shown in parentheses.

When the combined sorting processing is started, the processing unit U2 acquires the scan data SC1 read from the plurality of documents OR1 included in the document bundle OR0 from the image reading device 10 via the communication interface 106, and stores the scan data SC1 in the storage unit U1 (S102). In the example shown in FIG. 2, it is indicated that the scan data SC1 including the electronic data EL1 for 16 pages is acquired from the documents OR1 for 16 pages included in the document bundle OR0 and is stored in the storage unit U1.

After acquiring the scan data SC1, the processing unit U2 sequentially sets processing target pages from among the plurality of pages included in the scan data SC1 (S104). The processing unit U2 in the present specific example sets the processing target pages in the scan data SC1 in the order in which the number of pages increases from the first page.

After setting the processing target page, the processing unit U2 performs information acquisition processing of acquiring the information IN0 included in the identification code C0 (S106). In the information acquisition processing, the processing unit U2 acquires the identification information IN1 present in the first presence portion P1 from the information IN0 according to the item selected in the classification method selection field 508 shown in FIG. 6, and acquires the sorting information IN3 present in the second presence portion P2 from the information IN0 when an item other than the “complete match” item 553 is selected.

For example, when the “collection packaging commodity code” item 556 shown in FIG. 6 is selected, the processing unit U2 acquires the 14-digit information IN0 included in the collection packaging commodity code shown in FIG. 4, acquires the 12-digit single item identification information from the 14-digit information IN0 as identification information IN1, and acquires the first 1-digit indicator from the 14-digit information IN0 as the sorting information IN3.

When the “manufacturer code” item 557 shown in FIG. 6 is selected, the processing unit U2 acquires the 14-digit information IN0 included in the logistics commodity code shown in FIG. 4, acquires the 5-digit manufacturer identification information from the 14-digit information IN0 as the identification information IN1, and acquires the 5-digit commodity item identification information from the 14-digit information IN0 as the sorting information IN3.

When the “periodic publication code” item 551 shown in FIG. 6 is selected, the processing unit U2 acquires the 18-digit information IN0 included in the periodic publication code shown in FIG. 4, acquires the 5-digit periodic publication identification information from the 18-digit information IN0 as the identification information IN1, and acquires the 3-digit issue period from the 18-digit information IN0 as the sorting information IN3.

When the “user definition” item 554 shown in FIG. 6 is selected, the processing unit U2 acquires the information IN0 of the plurality of digits D0 included in the identification code C0 of the plurality of digits D0 shown in FIG. 7, acquires the identification information IN1 corresponding to the first digit D1 among the plurality of digits D0, and acquires the sorting information IN3 corresponding to the second digit D2 among the plurality of digits D0.

When the “complete match” item 553 shown in FIG. 6 is selected, the processing unit U2 does not acquire the sorting information IN3, and acquires the information IN0 included in the identification code C0 as the identification information IN1.

When the identification code C0 is present in the processing target page, the processing unit U2 acquires the identification information IN1 included in the identification code C0 and associates the identification information IN1 with the processing target page. For example, in the scan data SC1 shown in FIG. 2, since the identification code C0 is present in the third page, the identification information IN1 included in the identification code C0 is acquired and associated with the processing target page of the third page. When the identification code C0 is not present in the processing target page, when the previous page is associated with the identification information IN1, the identification information IN1 is associated with the processing target page, and when the previous page is not associated with the identification information IN1, the identification information IN1 is not associated with the processing target page. For example, since the identification code C0 is not present in the fourth page of the scan data SC1 shown in FIG. 2, the identification information IN1 associated with the third page is associated with the fourth page.

After the information acquisition processing, the processing unit U2 branches the processing depending on whether there is the identification information IN1 associated with the processing target page (S108). The processing unit U2 advances the processing to S110 when there is the identification information IN1 associated with the processing target page, and advances the processing to S120 when there is no identification information IN1 associated with the processing target page.

In S110, the processing unit U2 branches the processing depending on whether the identification information IN1 associated with the processing target page is new identification information that appears for the first time. For example, in the scan data SC1 shown in FIG. 2, when the processing target page is the third page, the identification information “10125” appears for the first time, and thus becomes the new identification information. When the processing target page is the fourth page, the identification information “10125” is existing identification information that already appeared.

When the identification information IN1 associated with the processing target page is the new identification information, the processing unit U2 advances the processing to S112, and creates a new group, which is a storage location of the electronic data EL1 associated with the new identification information, in the storage unit U1. Next, the processing unit U2 stores the electronic data EL1 corresponding to the processing target page in the new group (S114), and the processing proceeds to S120. In the example shown in FIG. 2, when the new identification information is the identification information “10125”, the file F1 for collecting the electronic data EL1 of the identification information “10125” is prepared in the storage unit U1, and the electronic data EL1 of the third page is stored in the file F1.

On the other hand, when the acquired identification information IN1 is the existing identification information, the processing unit U2 advances the processing to S116, adds the electronic data EL1 corresponding to the processing target page to the existing group which is the created storage location of the electronic data EL1 associated with the existing identification information, and advances the processing to S120. In the example shown in FIG. 2, the electronic data EL1 of the fourth page is added to the file F1 for collecting the electronic data EL1 of the identification information “10125”.

After the processing of S116, the processing unit U2 rearranges the electronic data EL1 stored in the existing group according to the order represented by the sorting information IN3 (S118). When the “complete match” item 553 shown in FIG. 6 is selected, the processing unit U2 does not perform the rearrangement processing of S118.

In S120, the processing unit U2 branches the processing depending on whether all pages included in the scan data SC1 are processed. When there is a page that is not set as the processing target page among the pages included in the scan data SC1, the processing unit U2 repeats the processing from S104 to S120. When all the pages included in the scan data SC1 are processed, the processing unit U2 advances the processing to S122.

FIG. 9 schematically shows a state in which the electronic data EL1 of the documents OR1 are collected according to the order represented by the sorting information IN3. FIG. 10 schematically shows a state in which the electronic data EL1 of the documents OR1 are rearranged according to the order represented by the sorting information IN3.

The document bundle OR0 shown in FIG. 9 includes the documents OR1 from p1 to p16. In the document bundle OR0, the identification code C2 including the identification information “20378” and the sorting information “3” is present at p1, the identification code C1 including the identification information “10125” and the sorting information 1 is present at p3, the identification code C2 including the identification information “20378” and the sorting information “1” is present at p7, the identification code C2 including the identification information “20378” and the sorting information “4” is present at p12, and the identification code C2 including the identification information “20378” and the sorting information “2” is present at p14. From the scan data SC1 read from the plurality of documents OR1, the electronic data EL1 of p1 and p2, p7 to p11, p12 and p13, and p14 to p16 associated with the identification information “20378” are stored in one storage location, and the electronic data EL1 of p3 to p6 associated with the identification information “10125” are stored in another storage location by the processing from S102 to S120 shown in FIG. 8. Since p3 to p6 associated with the identification information “10125” are associated with the same sorting information “1”, one file F1 having the electronic data EL1 of p3 to p6 in the page order is generated.

For the electronic data EL1 of the documents OR1 associated with the identification information “20378”, when the rearrangement processing of S118 is not performed, a file having the electronic data EL1 of the documents OR1 is generated in the order of p1 and p2, p7 to p11, p12 and p13, and p14 to p16. The processing unit U2 rearranges the electronic data EL1 of the documents OR1 based on the sorting information IN3 as shown in FIG. 10.

First, the processing unit U2 stores the electronic data EL1 of p1 and p2 associated with the sorting information “3” in the storage location. Next, the processing unit U2 sequentially arranges the electronic data EL1 of p7 to p11 associated with the sorting information “1” before the electronic data EL1 of p1 associated with the sorting information “3”. In the state ST1, the electronic data EL1 are stored in the storage location in the order of p7 to p11 and p1 and p2. Further, the processing unit U2 sequentially arranges the electronic data EL1 of p12 and p13 associated with the sorting information “4” after the electronic data EL1 of p2 associated with the sorting information “3”. In the state ST2, the electronic data EL1 are stored in the storage location in the order of p7 to p11, p1 and p2, and p12 and p13. Finally, the processing unit U2 arranges the electronic data EL1 of p14 to p16 associated with the sorting information “2” between the electronic data EL1 of p11 associated with the sorting information “1” and the electronic data EL1 of p1 associated with the sorting information “3” in order. In the state ST3, the electronic data EL1 are stored in the storage location in the order of p7 to p11, p14 to p16, p1 and p2, and p12 and p13. Therefore, the file F2 having the electronic data EL1 in the page order is generated.

In S122, the processing unit U2 performs storage processing of storing the file F0 in a set storage destination. Thereafter, the processing unit U2 ends the combined sorting processing. When the constraint condition is not set, the processing unit U2 stores the file F0 generated by the processing from S102 to S120 in the set storage destination. When the constraint condition is set, the processing unit U2 performs specific processing selected in the violation processing selection field 507 shown in FIG. 5. When the “divide file” is selected in the violation processing selection field 507, the processing unit U2 divides the file F0 based on the constraint condition and then stores the divided file F0 in the set storage destination. When the “display error” is selected in the violation processing selection field 507, the processing unit U2 displays an error on the display unit 200, performs processing of deleting a designated page from the file as necessary, and then stores the file F0 in the set storage destination. When the “suspend job” is selected in the violation processing selection field 507, the processing unit U2 causes the display unit 200 to display that the job is to be suspended.

As described above, in the combined sorting in which the electronic data EL1 of the documents OR1 associated with the common identification information IN1 are collected, the electronic data EL1 of the documents OR1 are collected according to the order represented by the sorting information IN3 included in the identification code C0.

For example, when the information IN0 included in the collection packaging commodity code shown in FIG. 3 is used as the identification information IN1 as it is, the file F0 is generated for each packaging form when the packaging form is different even for the same commodity. When the “collection packaging commodity code” item 556 shown in FIG. 6 is selected, the electronic data EL1 of the documents OR1 whose 12-digit single item identification information matches among the 14-digit information IN0 included in the collection packaging commodity code shown in FIG. 4 is generated in one file F0. Among these, the electronic data EL1 of the documents OR1 are arranged according to the order represented by the first 1-digit indicator. Therefore, the same commodity can be classified into one file regardless of the packaging form of the commodity, and can be arranged in the order of the packaging form.

The above example is suitable for automatic sorting of slips having the collection packaging commodity code.

The above example can also be applied to other examples by creating an identification code according to the specification of the identification code. For example, by allocating information indicating the storage location to the first 1-digit indicator of the identification code, it is possible to use the information for actual product management of an article.

When the information IN0 included in the logistics commodity code shown in FIG. 3 is used as the identification information IN1 as it is, the electronic data EL1 of the documents OR1 in which the first 1-digit logistics identification code, the 2-digit country code, the 5-digit manufacturer identification information, and the 5-digit commodity item identification information completely match are classified into one file F0. When the “manufacturer code” item 557 shown in FIG. 6 is selected, the electronic data EL1 of the documents OR1 having the same 5-digit manufacturer identification information among the 14-digit information IN0 included in the logistics commodity code shown in FIG. 4 are generated in one file F0. Among these, the electronic data EL1 of the documents OR1 are arranged according to the order represented by the commodity item identification information. Therefore, all commodity items of a specific manufacturer can be classified into one file, and can be arranged in the order of the commodity items.

The above example is suitable for automatic sorting of slips having the logistics commodity code.

When the commodity item identification information among the 14-digit information IN0 included in the logistics commodity code is set to the identification information IN1, the electronic data EL1 of the documents OR1 having the same commodity item identification information are generated in one file F0.

When the information IN0 included in the periodic publication code shown in FIG. 3 is used as the identification information IN1 as it is, the file F0 is generated for each issue period when the issue period is different even for the same periodic publication. When the “periodic publication code” item 551 shown in FIG. 6 is selected, the electronic data EL1 of the documents OR1 having the same 5-digit periodic publication identification information among the 18-digit information IN0 included in the periodic publication code shown in FIG. 4 is generated in one file F0. Among these, the electronic data EL1 of the documents OR1 are arranged according to the order represented by the 3-digit issue period. Therefore, regardless of the issue period of the periodic publication, the same periodic publication can be classified into one file, and can be arranged in the order of the issue period.

The above example is suitable for book stock management in bookstores and libraries, computerization of past publications, and the like.

As described above, in the specific example, the electronic data EL1 of the documents OR1 can be appropriately collected to generate output data, and the usability at the time of the combined sorting can be improved.

### (5) Modification

Various modifications are conceivable for the present disclosure.

For example, the processing of S102 shown in FIG. 8 is not limited to being performed when the scan data SC1 is received from the image reading device 10, and may be processing of reading the scan data SC1 stored in the storage device 104 into the RAM 103.

The rearrangement processing of S118 shown in FIG. 8 may be performed during a period from when it is determined in S120 that all pages included in the scan data SC1 are processed to when the file storage processing of S122 is performed.

The extraction data obtained by collecting the electronic data EL1 of the documents associated with the identification information IN1 among the plurality of documents OR1 is not limited to one file, and may be a collection of files in units of pages stored in a folder associated with the identification information IN1. As the file stored in the folder, a file in an image format such as a bitmap format can be adopted.

In the UI screen 500 shown in FIG. 5, a part of the display regions (501 to 509) may be omitted.

For example, even when the UI screen 500 shown in FIG. 5 does not include the constraint condition selection field 506 and the constraint condition is not set, a basic effect of appropriately collecting the electronic data of the documents in the combined sorting can be obtained.

Instead of the classification method selection field 508 shown in FIG. 5, a setting region for receiving settings of the first presence portion P1 and the second presence portion P2 may be provided on the UI screen 500. Also in this case, it is possible to obtain a basic effect of appropriately collecting the electronic data of the documents in the combined sorting.

### (6) Conclusion

As described above, according to the present disclosure, it is possible to provide a technique and the like capable of appropriately collecting electronic data of documents in the combined sorting according to various aspects. Of course, the above described basic functions and effects can be obtained even with a technique including only the constituent requirements according to the independent claims. In addition, it is also possible to implement a configuration in which components disclosed in the above described examples are replaced with one another or a combination of the components is changed, a configuration in which components disclosed in a known technique and examples described above are replaced with one another or a combination of the components is changed, and the like. The present disclosure also includes such configurations and the like.

What is claimed is:

1. An information processing device comprising:
a storage unit configured to store scan data read from a plurality of documents; and
a processing unit configured to acquire information indicated by an identification code present in the plurality of documents based on the scan data and edit the scan data according to the information, wherein the editing includes rearranging pages of the scan data according to the information.

2. The information processing device according to claim 1, further comprising:
a reception unit configured to receive a setting of specifying a first presence portion of the identification code indicating identification information, wherein the processing unit acquires the identification information indicated by the first presence portion, extracts a partial page of the scan data according to the acquired identification information, and generates extraction data.

3. The information processing device according to claim 2, wherein the reception unit is configured to receive a setting of specifying a second presence portion of the identification code indicating second information, and the processing unit acquires the second information indicated by the second presence portion, and rearranges the pages of the scan data according to the acquired second information.

4. The information processing device according to claim 3, wherein the reception unit is configured to receive a setting of a first digit that is the first presence portion and a second digit that is the second presence portion, the identification code being a sequence of a plurality of digits, and the processing unit is configured to acquire, when the setting of the first digit is received, the identification information corresponding to the first digit among the plurality of digits, and acquire, when the setting of the second digit is received, sorting information corresponding to the second digit among the plurality of digits.

5. The information processing device according to claim 3, wherein the reception unit is configured to receive a collection packaging commodity code acquisition setting of acquiring the information included in a collection packaging commodity code as the identification code, and when the reception unit receives the collection packaging commodity code acquisition setting, the reception unit sets, as the first presence portion, a portion in the information included in the collection packaging commodity code in which single item identification information of identifying a single item included in collection packaging is present, and sets, as the second presence portion, a portion in the information included in the collection packaging commodity code in which an indicator is present.

6. The information processing device according to claim 3, wherein the reception unit is configured to receive a periodic publication code acquisition setting of acquiring the information included in a periodic publication code as the identification code, and when the periodic publication code acquisition setting is received, the reception unit sets, as the first presence portion, a portion in which periodic publication code identification information of identifying a periodic publication is present in the information included in the periodic publication code, and sets, as the second presence portion, a portion in the information included in the periodic publication code in which an issue period is present.

7. The information processing device according to claim 3, wherein the reception unit is configured to receive a logistics commodity code acquisition setting of acquiring the information included in a logistics commodity code as the identification code including manufacturer identification information for identifying a manufacturer of a commodity item group and commodity item identification information for identifying a commodity item included in the commodity item group, and when the logistics commodity code acquisition setting is received, the reception unit sets, as the first presence portion, a portion in which the manufacturer identification information is present in the information included in the logistics commodity code, and sets, as the second presence portion, a portion in which the commodity item identification information is present in the information included in the logistics commodity code.

8. The information processing device according to claim 2, wherein the reception unit is configured to receive a complete match setting in which the identification code indicates only the identification information, and when the complete match setting is received, the processing unit further generates the extraction data without rearranging the pages of the scan data.

9. The information processing device according to claim 1, wherein the processing unit is configured to set a processing target page in order from among a plurality of pages included in the scan data, create a storage location and store the processing target page when the processing target page is a first page among pages to be extracted, and add the processing target page to the storage location and rearrange the pages when the processing target page is a second page among the pages to be extracted.

10. The information processing device according to claim 1, further comprising:
a communication unit configured to receive the scan data from an image reading device, wherein the storage unit stores the received scan data.

11. An output data generation method of generating output data by processing scan data read from documents including a plurality of pages, the method comprising:
an acquisition step of acquiring, based on the scan data, information indicated by an identification code present in the plurality of documents; and
a generation step of generating output data by editing the scan data according to the acquired information, wherein the editing includes rearranging the pages of the scan data according to the information.

12. A non-transitory computer-readable storage medium storing a scan data processing program configured to process scan data read from a plurality of documents, the program causing a computer to implement:
an acquisition function of acquiring, based on the scan data, information indicated by an identification code present in the plurality of documents; and
a generation function of generating output data by editing the scan data according to the acquired information, wherein the editing includes rearranging the pages of the scan data according to the information.
